(19) United States
(12) Patent Application Publication
(10) Pub. No.: US 2014/0057714 A1
(43) Pub. Date: Feb. 27, 2014

(54) MODIFIABLE GAMING EXPERIENCE BASED ON USER POSITION AND/OR ORIENTATION

(71) Applicant: GANESH M. PHADAKE, Pune (IN)

(72) Inventor: GANESH M. PHADAKE, Pune (IN)

(73) Assignee: NVIDIA Corporation, Santa Clara, CA (US)

(21) Appl. No.: 13/594,950

(22) Filed: Aug. 27, 2012

(51) Int. Cl. A63F 13/00

(52) U.S. Cl. 463/31

(57) ABSTRACT

A method includes sensing, during a gaming experience of a user on a gaming system, position and/or orientation of the user through a motion sensor incorporated into a pair of goggles worn by the user to enhance the gaming experience, and wirelessly transmitting the sensed position and/or the orientation of the user from the pair of goggles to a wireless circuit of the gaming system coupled to a processor thereof. The method also includes effecting, through the processor, an automatic intelligent modification of the gaming experience of the user based on the wirelessly transmitted sensed position and/or the orientation of the user in accordance with regarding the pair of goggles as an input device of the gaming system.

### FIELD OF TECHNOLOGY

This disclosure relates generally to gaming systems and, more particularly, to modification of a gaming experience of a user on a gaming system based on position and/or orientation data thereof.

### BACKGROUND

Gaming on a gaming system (e.g., a gaming console, a computing device) may involve a user thereof desiring modification of one or more virtual representations of objects (e.g., planes, cars) and/or characters (e.g., enemies) during a course of a gaming experience thereon. For example, the user may desire to have an enemy character face him/her during the course of the gaming experience. The aforementioned modification(s) may provide for user satisfaction with regard to the gaming experience. However, one or more features/capabilities/virtual representations desired by the user may not be available during gaming on the gaming system. Even if the one or more features and/or capabilities were available, realization thereof may be extremely tedious, thereby causing the user to possibly lose interest in gaming on the gaming system.

### SUMMARY

Disclosed are a method, an apparatus and/or a system of modification of a gaming experience of a user on a gaming system based on position and/or orientation data thereof.

In one aspect, a method includes sensing, during a gaming experience of a user on a gaming system, position and/or orientation of the user through a motion sensor incorporated into a pair of goggles worn by the user to enhance the gaming experience, and wirelessly transmitting the sensed position and/or the orientation of the user from the pair of goggles to a wireless circuit of the gaming system coupled to a processor thereof. The method also includes effecting, through the processor, an automatic intelligent modification of the gaming experience of the user based on the wirelessly transmitted sensed position and/or the orientation of the user in accordance with regarding the pair of goggles as an input device of the gaming system.

In another aspect, a gaming system includes processor, a memory including storage locations configured to be addressable through the processor, a wireless circuit coupled to the processor, and a pair of goggles wirelessly coupled to the wireless circuit to enhance a gaming experience of a user on the gaming system when worn by the user. The pair of goggles includes a motion sensor incorporated therein to sense, during the gaming experience, position and/or orientation of the user. The pair of goggles is configured to wirelessly transmit the sensed position and/or the orientation of the user to the wireless circuit to enable the processor to effect an automatic intelligent modification of the gaming experience of the user based on the wirelessly transmitted sensed position and/or the orientation of the user in accordance with regarding the pair of goggles as an input device of the gaming system.

In yet another aspect, a non-transitory machine-readable medium, readable through a gaming system and including instructions embodied therein that are executable on the gaming system, includes instructions to wirelessly receive, during a gaming experience of a user on the gaming system, position and/or orientation of the user sensed through a motion sensor incorporated into a pair of goggles worn by the user to enhance the gaming experience through a wireless circuit of the gaming system coupled to a processor thereof. The non-transitory machine-readable medium also includes instructions to effect, through the processor, an automatic intelligent modification of the gaming experience of the user based on the wirelessly received sensed position and/or the orientation of the user in accordance with regarding the pair of goggles as an input device of the gaming system.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a gaming system, according to one or more embodiments.

FIG. 2 is a schematic and an illustrative view of a pair of goggles configured to be worn by a user of the gaming system of FIG. 1 to enhance a gaming experience thereof, according to one or more embodiments.

FIG. 3 is an illustrative view of an example scenario of modification of a virtual representation as part of the gaming experience of the user of the gaming system of FIG. 1 on a gaming console.

FIG. 4 is another illustrative view of the example scenario of modification of the virtual representation as part of the gaming experience of the user of the gaming system of FIG. 1 on the gaming console of FIG. 3.

FIG. 5 is a schematic view of a processor and a memory of the gaming system of FIG. 1.

FIG. 6 is an illustrative view of another example scenario of modification of a virtual representation as part of the gaming experience of the user of the gaming system of FIG. 1 on the gaming console of FIG. 3.

FIG. 7 is a process flow diagram detailing the operations involved in a method of intelligently modifying a gaming experience of a user on a gaming system based on position and/or orientation data thereof, according to one or more embodiments.

Other features of the present embodiments will be apparent from the accompanying drawings and from the detailed description that follows.

### DETAILED DESCRIPTION

Example embodiments, as described below, may be used to provide a method, an apparatus and/or a system of modification of a gaming experience of a user on a gaming system based on position and/or orientation data thereof. Although the present embodiments have been described with reference to specific example embodiments, it will be evident that various modifications and changes may be made to these embodiments without departing from the broader spirit and scope of the various embodiments.

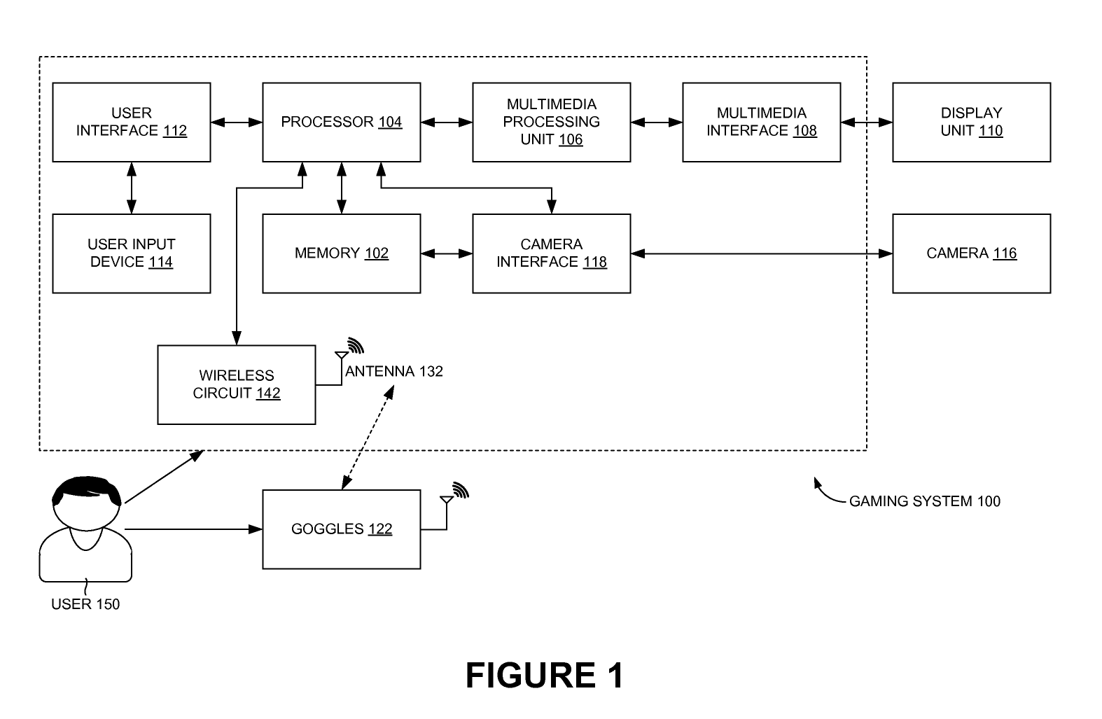

FIG. 1 shows a gaming system 100, according to one or more embodiments. In one or more embodiments, gaming system 100 may include a computing device (e.g., a desktop computer, laptop computer, notebook computer, a mobile device such as a mobile phone) or a gaming console, on which a user 150 may execute/play games available on non-transitory machine-readable media such as Compact Discs (CDs), Digital Video Discs (DVDs), Blu-Ray™ discs and gaming cartridges, or on downloaded files stored in a memory 102 (e.g., hard drive) of gaming system 100. In one or more embodiments, user 150 may access remotely hosted games through a network (e.g., Internet). Examples of gaming consoles include but are not limited to Nintendo GameCube™, Nintendo®'s Gameboy® Advance, Sony®'s PlayStation® console, Nintendo®'s Wii®, and Microsoft®'s Xbox 360®.

In one or more embodiments, memory 102 of gaming system 100 may include a volatile memory (e.g., Random Access Memory (RAM)) and/or a non-volatile memory (e.g., Read-Only Memory (ROM), hard disk). In one or more embodiments, at least some portion of memory 102 (e.g., ROM) may be part of a processor 104 of gaming system 100. In one or more embodiments, processor 104 may include a Central Processing Unit (CPU) and/or a Graphics Processing Unit (GPU). In another embodiment, memory 102 may be separate from processor 104. In one or more embodiments involving a GPU, the GPU may be configured to perform intensive graphics processing. Alternately, two or more GPUs may be provided in gaming system 100 to perform the abovementioned graphics processing. In one or more embodiments, memory 102 may include storage locations configured to be addressable through processor 104. In one or more embodiments, when gaming system 100 is powered ON (e.g., by powering ON gaming console, by powering ON computing device), instructions associated with loading an operating system therein (e.g., resident in a hard disk associated with memory 102) stored in memory 102 (e.g., non-volatile memory) may be executed through processor 104.

In one or more embodiments, output data associated with processing through processor 104 may be input to a multimedia processing unit 106 configured to perform encoding/decoding associated with the data. In one or more embodiments, the output of multimedia processing unit 106 may be rendered on a display unit 110 through a multimedia interface 108 configured to convert data to an appropriate format required by display unit 110. In one or more embodiments, display unit 110 may be a computer monitor/display (e.g., Liquid Crystal Display (LCD) monitor, Cathode Ray Tube (CRT) monitor) associated with gaming system 100. In one or more embodiments, display unit 110 may also be a monitor/display embedded in the gaming console.

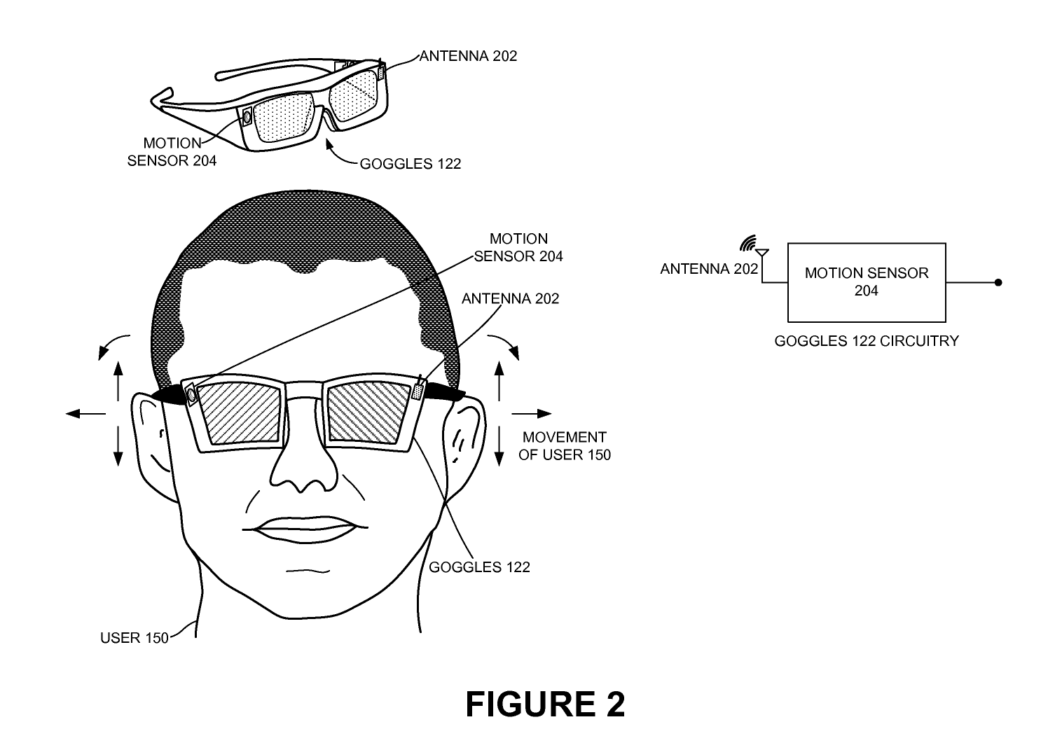

In one or more embodiments, a user interface 112 (e.g., a game port, a Universal Serial Bus (USB) port) interfaced with processor 104 may be provided in gaming system 100 to enable coupling of a user input device 114 to processor 104 therethrough. In one or more embodiments, user input device 114 may include a keyboard/keypad and/or a pointing device (e.g., mouse, touch pad, trackball). In one or more embodiments, user input device 114 may also include a joystick or a gamepad. In one or more exemplary embodiments, gaming system 100 may include another user input device in the form of a pair of goggles 122 (e.g., stereoscopic three-dimensional (3D) glasses, 2D glasses) with a motion sensor (e.g., motion sensor 204, as shown in FIG. 2; an example motion sensor 204 may be an accelerometer) embedded therein. In one or more embodiments, goggles 122 may be utilized to enhance the gaming experience of user 150, along with enabling user 150 to input data (to be discussed in detail below) into processor 104 that may be interpreted as “emotion(s)” of user 150.

In one or more embodiments, goggles 122 may be wirelessly coupled (e.g., through a wireless communication channel such as Bluetooth®) to gaming system 100 by way of a wireless circuit 142. FIG. 1 shows wireless circuit 142 being coupled to processor 104 of gaming system 100, with wireless circuit 142 having an antenna 132 configure to receive the input data from goggles 122. It is obvious that goggles 122 may have a corresponding antenna 202 (shown in FIG. 2) to transmit the input data to wireless circuit 142. Examples of wireless circuit 142 (e.g., a receiver circuit) are well known to one of ordinary skill in the art and, therefore, discussion associated therewith has been skipped for the sake of brevity and convenience.

Goggles 122 may be commercially available as a part/an accessory of gaming system 100. Alternately, goggles 122 compatible with gaming system 100 may be commercially available separately from gaming system 100. FIG. 2 shows a pair of goggles 122 configured to be worn by user 150 to enhance a gaming experience thereof, according to one or more embodiments. In one or more embodiments, as discussed above, goggles 122 may include antenna 202 configured to wirelessly transmit the input data to wireless circuit 142 (or, antenna 132). In one or more embodiments, goggles 122 may include motion sensor 204 configured to sense motion of user 150 wearing goggles 122 due to a positional and/or an orientational change in the face of user 150. In one or more embodiments, the aforementioned sensed data from motion sensor 204 may be communicated as the input data from goggles 122 through antenna 202. It is obvious that motion sensor 204 may have a data processing circuit (not shown) to convert the sensed data into a form compatible with transmission through antenna 202. FIG. 2 shows motion sensor 204 as being coupled to antenna 202.

In one or more embodiments, gaming system 100 may optionally also include a camera 116 (e.g., a still camera, a video camera) configured to capture a “live” (e.g., real-time) image/video of user 150 of gaming system 100. In one or more embodiments, camera 116 may be coupled to processor 104 and/or memory 102 through a camera interface 118. In one or more embodiments, camera 116 may be analogous to user input device 114, but may be configured to capture the “live” image/video of user 150 with/without the knowledge of user 150. It is obvious that camera interface 118 may be analogous to user interface 112. In one or more embodiments, camera 116 may either be external (e.g., not part of gaming system 100) to gaming system 100 or internal thereto. In one or more embodiments, camera 116 may be part of the gaming console/computing device discussed above. In one or more embodiments, in case of external camera(s), an appropriate interface may be provided in gaming system 100 to enable coupling of gaming system 100 to the external camera(s).

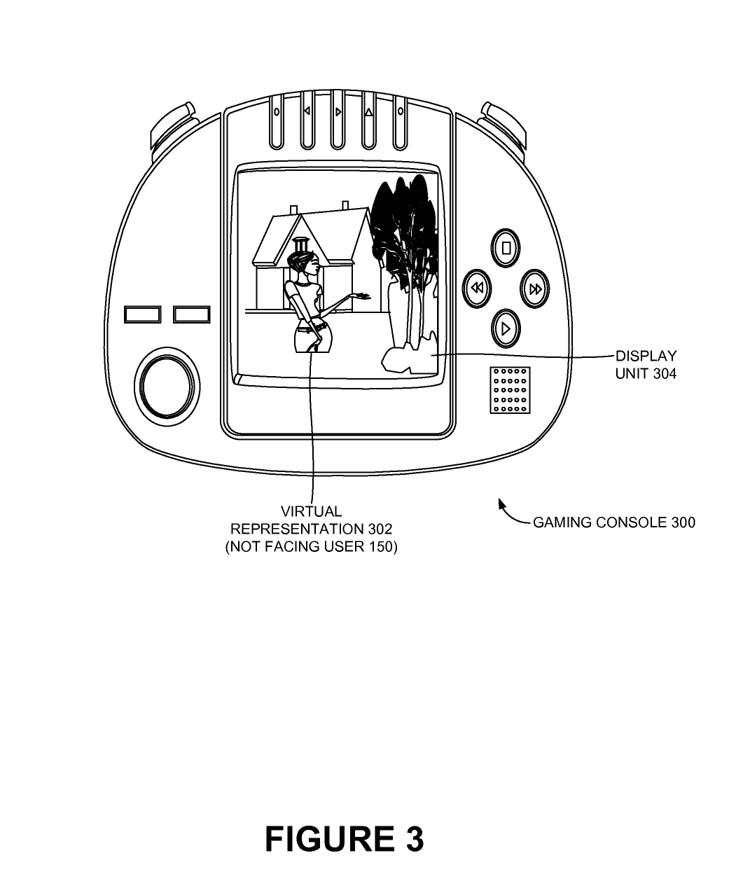

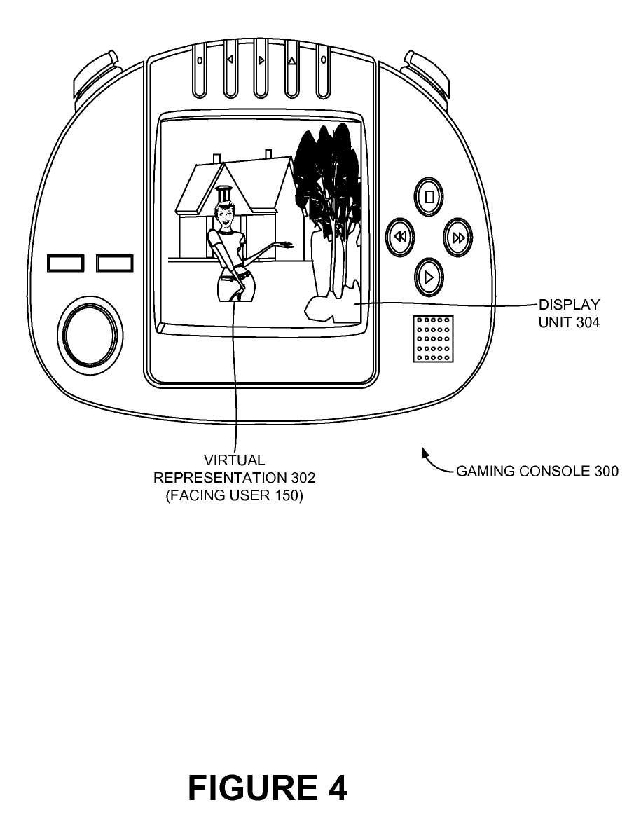

In one or more embodiments, a virtual representation of an object (e.g., a car, a plane) or an entity (e.g., an enemy) may be a regular feature of games played by user 150 on gaming system 100. The aforementioned virtual representation may have a position and/or orientation thereof within the context of the gaming experience of user 150 modified based on the input data from goggles 122. FIGS. 3-4 illustrate an example scenario of modification of position and/or orientation of a virtual representation 302 as part of a gaming experience of user 150, virtual representation 302 being shown on a display unit 304 (analogous to display unit 110) of a gaming console 300. As shown in FIG. 3, an example virtual representation 302 of an enemy character may not be facing user 150 during the gaming experience thereof. Goggles 122 may detect movement of user 150 to detect the presence thereof. The aforementioned detection may trigger an appropriate input data being transmitted from goggles 122 to gaming system 100 by way of wireless circuit 142.

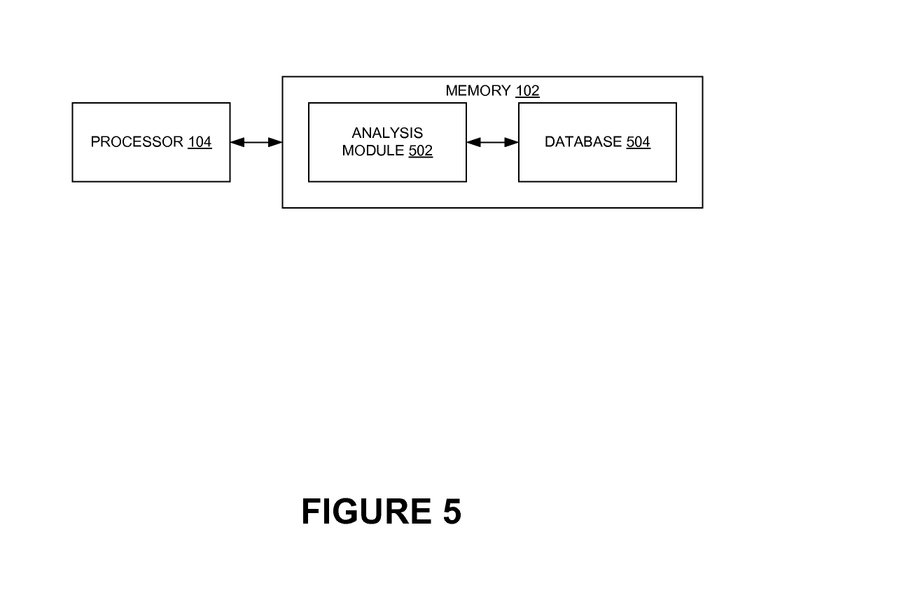

Based on the received input data, processor 104 may be configured to execute an analysis module 502 (shown in FIG. 5) to cause virtual representation 302 to face user 150 and/or to make “eye contact” therewith. A number of manifestations of virtual representation 302 may be stored in a database 504 (see FIG. 5) that, for example, may be made available in memory 102 following installation of a game. Thus, based on the received input data from goggles 122, processor 104 may be configured to choose the appropriate manifestation of virtual representation 302 that faces user 150 and/or makes “eye contact” therewith and update virtual representation 302, as shown in FIG. 4. Alternately, processor 104 may be configured to enable creation of a new virtual representation 302 to replace the previous version thereof. The aforementioned newly created virtual representation 302 may then be stored in database 504 for future use.

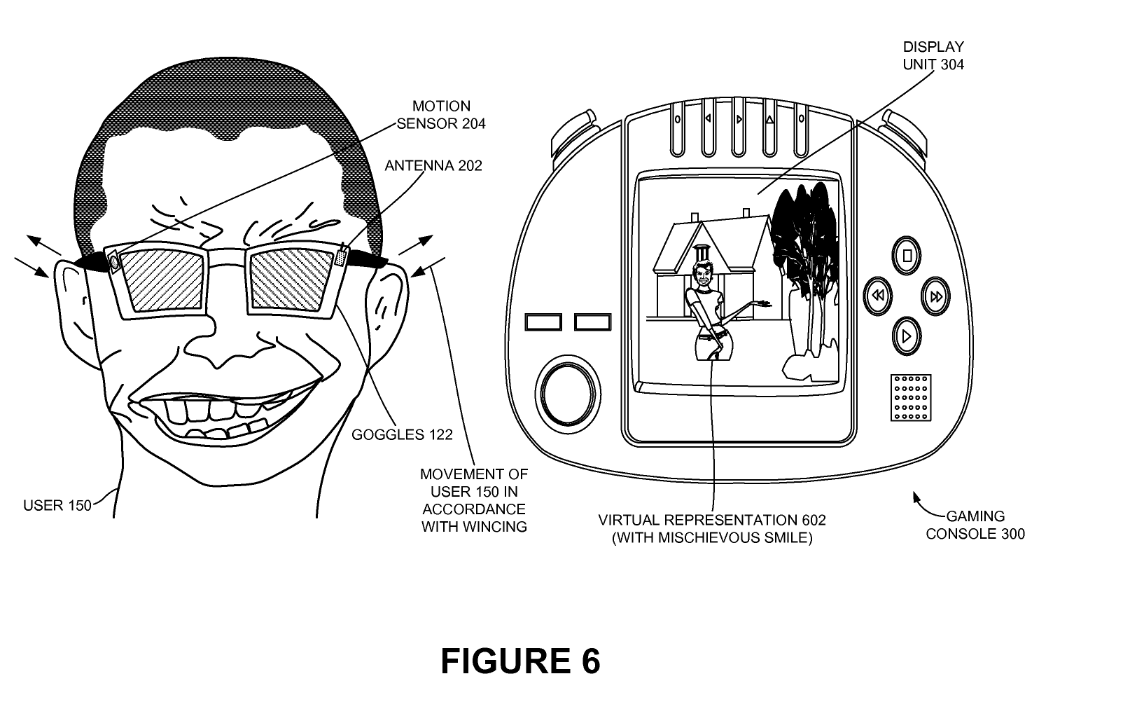

FIG. 5 shows processor 104 and memory 102 of gaming system 100 alone. As shown in FIG. 5, memory 102 may include instructions associated with analysis module 502 stored therein that are configured to be executable through processor 104. Moreover, FIG. 5 also shows memory 102 as including database 504. In one or more gaming experience(s) of user 150, user 150 may react to, for example, an attack by an enemy character by wincing. The aforementioned action of wincing on part of user 150 may enable goggles 122 to detect position and/or orientation modification associated therewith. For example, user 150 may wince a few times, and the aforementioned actions may cause input data to be transmitted to gaming system 100, where processor 104 may “intelligently” (e.g., through pattern identification by executing analysis module 502) determine the actions to correspond to wincing on part of user 150. Following the aforementioned determination by processor 104, processor 104 may cause virtual representation 602 of the enemy character to mischievously smile at user 150, as shown in FIG. 6. Thus, exemplary embodiments provide a way for “emotions” to be interpreted by gaming system 100 and the gaming experience of user 150 appropriately enhanced based on the interpretation of “emotions.”

Again, it is obvious that the modified virtual representation 602 of a mischievously smiling enemy character may either be available in database 504 or created during the gaming experience. Further, the aforementioned newly created virtual representation 602 may be stored in database 504 for future use.

Other forms of enhancing gaming experience of user 150 based on input data from goggles 122 are within the scope of the exemplary embodiments discussed herein. For example, a direction of a virtual representation of an object (e.g., a car, a motorbike) or an entity (e.g., a driver of the car, a driver of the motorbike) may be controlled based on directional data of user 150 transmitted from goggles 122. As per the direction control, whenever user 150 moves his/her head to his/her left, the virtual representation may also be caused to move in a corresponding direction. In another example gaming experience, whenever user 150 moves his/her head down, a virtual representation of his/her character (e.g., avatar) may “virtually” sit down.

It is obvious to note that the possibilities of enhancing gaming experience(s) through goggles 122 may enable goggles 122 to wholly or partially substitute functionalities associated with user input device 114 (e.g., joystick). For example, as discussed above, user 150 may merely be required to move his/her head in one particular direction for a virtual representation to move in that direction. Thus, the gaming experience of user 150 may be enhanced by dispensing (at least partially) with the use of a joystick or a button-pad (and buttons thereon), thereby enabling goggles 122 to substitute (at least partially) the joystick or the button-pad. In another example, user 150 may merely be required to nod his/her head in answer to a question posed thereto during the gaming experience in order for gaming system 100 to interpret the action appropriately. For instance, nodding in a vertical direction may be interpreted as “Yes” and nodding in a horizontal direction may be interpreted as “No.”

In one or more embodiments, movement “patterns” of user 150 may be identified based on the input data from goggles 122 to cause the gaming experience of user 150 to be livelier and more interactive. In one or more embodiments, camera 116 may serve to aid and/or enhance the “pattern” detection of user 150 based on capturing “live” images/videos of user 150 that are utilized by processor 104 to identify user 150 “emotions” (e.g., through facial recognition algorithms stored in analysis module 502).

In one or more embodiments, in a networked gaming environment, the database including possible virtual representations may be remotely located on a host server. In one or more embodiments, the virtual representation newly created during the gaming experience of user 150 may be locally stored in database 504 of memory 102 of gaming system 100. In one or more embodiments, this locally stored database 504 may serve as a profile of user 150. It is obvious that this profile of user 150 may also be available on the remote database on the host server. For example, user 150 may be empowered (e.g., through processor 104) with the ability to make the newly created virtual representation “public,” i.e., available to and utilizable by other users of the networked gaming environment.

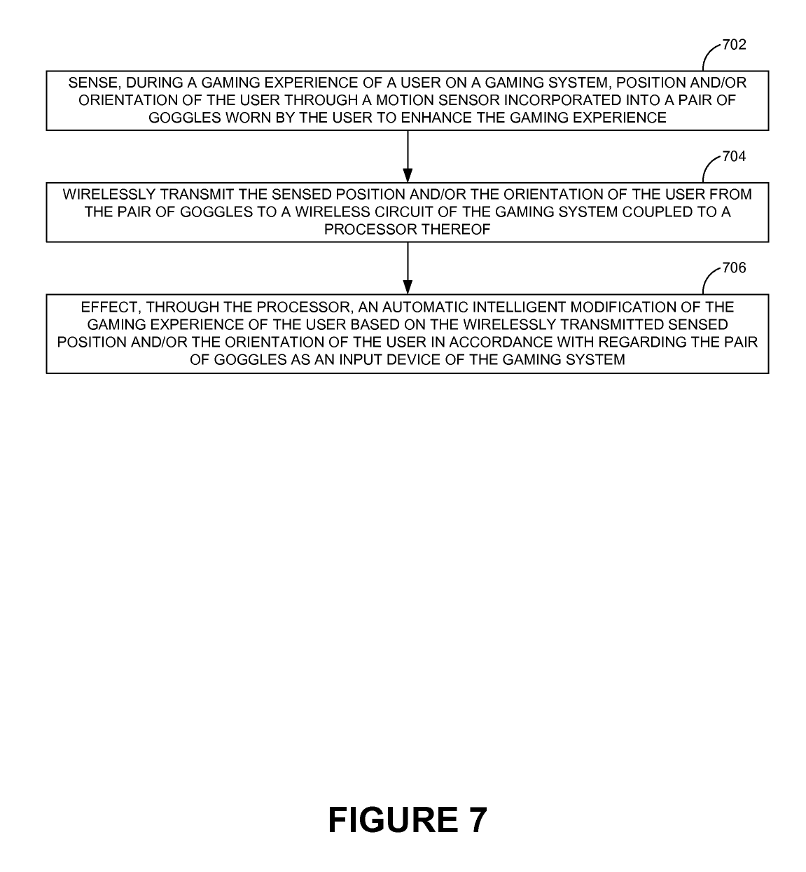

FIG. 7 shows a process flow diagram detailing the operations involved in a method of intelligently modifying a gaming experience of user 150 on gaming system 100 based on position and/or orientation data thereof, according to one or more embodiments. In one or more embodiments, operation 702 may involve sensing, during the gaming experience of user 150 on gaming system 100, position and/or orientation of user 150 through a motion sensor 204 incorporated into a pair of goggles 122 worn by user 150 to enhance the gaming experience. In one or more embodiments, operation 704 may involve wirelessly transmitting the sensed position and/or the orientation of user 150 from the pair of goggles 122 to a wireless circuit 142 of gaming system 100 coupled to a processor 104 thereof.

In one or more embodiments, operation 706 may then involve effecting, through processor 104, an automatic intelligent modification of the gaming experience of user 150 based on the wirelessly transmitted sensed position and/or the orientation of user 150 in accordance with regarding the pair of goggles 122 as an input device of gaming system 100.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry, firmware, software or any combination of hardware, firmware, and software (e.g., embodied in a non-transitory machine-readable medium). For example, the various electrical structure and methods may be embodied using transistors, logic gates, and electrical circuits (e.g., Application Specific Integrated Circuitry (ASIC) and/or Digital Signal Processor (DSP) circuitry).

In addition, it will be appreciated that the various operations, processes, and methods disclosed herein may be embodied in a non-transitory machine-readable medium and/or a machine accessible medium compatible with a data processing system (e.g., a computer device), and may be performed in any order (e.g., including using means for achieving the various operations). Various operations discussed above may be tangibly embodied on a non-transitory machine-readable medium readable through gaming system 100 to perform functions through operations on input and generation of output. These input and output operations may be performed by a processor (e.g., processor 104). The non-transitory machine-readable medium readable through gaming system 100 may be, for example, a memory, a transportable medium such as a CD, a DVD, a Blu-ray™ disc, a floppy disk, or a diskette. The non-transitory machine-readable medium may include instructions embodied therein that are executable on gaming system 100. A computer program embodying the aspects of the exemplary embodiments may be loaded onto gaming system 100. The computer program is not limited to specific embodiments discussed above, and may, for example, be implemented in an operating system, an application program, a foreground or a background process, a driver, a network stack or any combination thereof. For example, software associated with goggles 122 and/or camera 116 may be available on the non-transitory machine-readable medium readable through gaming system 100. The computer program may be executed on a single computer processor or multiple computer processors.

Accordingly, the specification and drawings are to be regarded in an illustrative rather than a restrictive sense.

What is claimed is:

1. A method comprising:
sensing, during a gaming experience of a user on a gaming system, at least one of position and orientation of the user through a motion sensor incorporated into a pair of goggles worn by the user to enhance the gaming experience;
wirelessly transmitting the sensed at least one of the position and the orientation of the user from the pair of goggles to a wireless circuit of the gaming system coupled to a processor thereof; and
effecting, through the processor, an automatic intelligent modification of the gaming experience of the user based on the wirelessly transmitted sensed at least one of the position and the orientation of the user in accordance with regarding the pair of goggles as an input device of the gaming system.

2. The method of claim 1, wherein the automatic intelligent modification of the gaming experience includes at least one of:
modifying a virtual representation of at least one of an object and a character forming a part of the gaming experience on a display unit of the gaming system; and
at least partially performing a function of another input device of the gaming system through the pair of goggles.

3. The method of claim 2, wherein modifying the virtual representation of the at least one of the object and the character includes at least one of:
enabling, through the processor, creation of a new virtual representation to replace the virtual representation; and
choosing, through the processor, the new virtual representation from a number of manifestations of the virtual representation available in a database of a memory of the gaming system, the memory including storage locations configured to be addressable through the processor.

4. The method of claim 3, further comprising storing the newly created virtual representation in the database including the number of manifestations of the virtual representation.

5. The method of claim 1, comprising effecting the automatic intelligent modification of the gaming experience of the user based on identifying a pattern in the wireles sly transmitted sensed at least one of the position and the orientation of the user.

6. The method of claim 5, further comprising utilizing a camera to capture at least one of an image and a video of the user during the gaming experience to at least one of aid and enhance the pattern identification.

7. The method of claim 4, wherein when the gaming experience occurs in a networked gaming environment, the method further comprises providing a capability to make available the stored newly created virtual representation to other users of the networked gaming environment.

8. A gaming system comprising:
a processor;
a memory including storage locations configured to be addressable through the processor;
a wireless circuit coupled to the processor; and
a pair of goggles wirelessly coupled to the wireless circuit to enhance a gaming experience of a user on the gaming system when worn by the user, the pair of goggles including a motion sensor incorporated therein to sense, during the gaming experience, at least one of position and orientation of the user, and the pair of goggles being configured to wirelessly transmit the sensed at least one of the position and the orientation of the user to the wireless circuit to enable the processor to effect an automatic intelligent modification of the gaming experience of the user based on the wirelessly transmitted sensed at least one of the position and the orientation of the user in accordance with regarding the pair of goggles as an input device of the gaming system.

9. The gaming system of claim 8,
wherein the gaming system further comprises a display unit, and
wherein the processor is configured to effect the automatic intelligent modification of the gaming experience through at least one of:
modifying a virtual representation of at least one of an object and a character forming a part of the gaming experience on the display unit, and
at least partially performing a function of another input device of the gaming system through the pair of goggles.

10. The gaming system of claim 9, wherein the processor is configured to enable the modification of the virtual representation of the at least one of the object and the character through at least one of:
enabling creation of a new virtual representation to replace the virtual representation, and
choosing the new virtual representation from a number of manifestations of the virtual representation available in a database of the memory.

11. The gaming system of claim 10, wherein the newly created virtual representation is configured to be stored in the database including the number of manifestations of the virtual representation.

12. The gaming system of claim 8, wherein the processor is configured to effect the automatic intelligent modification of the gaming experience of the user based on identifying a pattern in the wirelessly transmitted sensed at least one of the position and the orientation of the user.

13. The gaming system of claim 12, further comprising a camera communicatively coupled to the processor through an interface to capture at least one of an image and a video of the user during the gaming experience to at least one of aid and enhance the pattern identification.

14. The gaming system of claim 11, wherein when the gaming experience occurs in a networked gaming environment, the process is further configured to provide a capability to make available the stored newly created virtual representation to other users of the networked gaming environment.

15. A non-transitory machine-readable medium, readable through a gaming system and including instructions embodied therein that are executable on the gaming system, comprising:
instructions to wirelessly receive, during a gaming experience of a user on the gaming system, at least one of position and orientation of the user sensed through a motion sensor incorporated into a pair of goggles worn by the user to enhance the gaming experience through a wireless circuit of the gaming system coupled to a processor thereof; and
instructions to effect, through the processor, an automatic intelligent modification of the gaming experience of the user based on the wirelessly received sensed at least one of the position and the orientation of the user in accordance with regarding the pair of goggles as an input device of the gaming system.

16. The non-transitory machine-readable medium of claim 15, comprising instructions to at least one of:
modify a virtual representation of at least one of an object and a character forming a part of the gaming experience on a display unit of the gaming system; and
at least partially performing a function of another input device of the gaming system through the pair of goggles.

17. The non-transitory machine-readable medium of claim 16, comprising instructions to at least one of:
enable, through the processor, creation of a new virtual representation to replace the virtual representation; and
choose, through the processor, the new virtual representation from a number of manifestations of the virtual representation available in a database of a memory of the gaming system, the memory including storage locations configured to be addressable through the processor.

18. The non-transitory machine-readable medium of claim 17, further comprising instructions to store the newly created virtual representation in the database including the number of manifestations of the virtual representation.

19. The non-transitory machine-readable medium of claim 15, comprising instructions to effect the automatic intelligent modification of the gaming experience of the user based on identifying a pattern in the wirelessly received sensed at least one of the position and the orientation of the user.

20. The non-transitory machine-readable medium of claim 19, further comprising instructions to enable utilization of a camera to capture at least one of an image and a video of the user during the gaming experience to at least one of aid and enhance the pattern identification.

21. The non-transitory machine-readable medium of claim 18, wherein when the gaming experience occurs in a networked gaming environment, the non-transitory machine-readable medium further comprises instructions to provide a capability to make available the stored newly created virtual representation to other users of the networked gaming environment.
